(19) United States
(12) Patent Application Publication
(10) Pub. No.: US 2007/0019145 A1
(43) Pub. Date: Jan. 25, 2007

(54) Display device

(75) Inventors: Nam-seok Rho, Gyeonggi-do (KR); Baek-woon Lee, Gyeonggi-do (KR); Mun-pyo Hong, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/490,265

(22) Filed: Jul. 19, 2006

(30) Foreign Application Priority Data
Jul. 19, 2005 (KR) 2005-0065455

(51) Int. Cl. G02F 1/1343; G02F 1/1335

(52) U.S. Cl. 349/144; 349/70

(57) ABSTRACT

The present invention relates to a display device comprising a gate line; a data line insulated from the gate line and crossing the gate line; and a pixel area connected to a TFT formed at an intersection of the gate line and the data line and having a red, a green, a blue, and a white subpixels which are disposed in a 2×2 matrix, wherein one of areas of the red subpixel, the green subpixel, and the blue subpixel, and an area of the white subpixel are less than 25% of an area of the pixel area, respectively. Thus, the present invention provides a liquid crystal display to display images by properly adjusting color balance.

### CROSS-REFERENCE TO RELATED APPLICATIONS

This application claims the benefit of Korean Patent Application No. 2005-0065455, filed on Jul. 19, 2005, in the Korean Intellectual Property Office, which is hereby incorporated by reference for all purposes as if fully set forth herein.

### BACKGROUND

1. Field of the Invention

The present invention relates to a liquid crystal display, and more particularly, to a liquid crystal display using 4 colors.

2. Description of the Related Art

A liquid crystal display (LCD) includes an LCD panel including a thin film transistor (TFT) substrate where TFTs are formed and a color filter substrate where color filter layers are formed. A liquid crystal layer is formed between the TFT substrate and the color filter substrate.

On the TFT substrate are arranged a plurality of gate lines and a plurality of data lines to cross each other, and the TFT is disposed at the intersection of both lines. A data voltage, which is an image signal, is transmitted to the liquid crystal layer through a pixel electrode electrically connected to the TFT. On the color filter substrate are disposed a red, a green, and a blue color filter layer corresponding to the pixel electrode, and a square dot has typically been comprised of a red, a green, and a blue subpixel.

Recently, an LCD using 4 colors has been developed, which includes a white subpixel without color or further includes an extra color subpixel in addition to the red, the green, and the blue subpixels in order to enhance brightness. When an image is displayed with a dot including the white subpixel in addition to the red, the green, and the blue subpixels, light efficiency is enhanced.

However, since the white subpixel forms ¼ of a dot, it becomes more difficult to display a pure red, a pure green, or a pure blue color as compared with the conventional LCD, and color density also becomes lower under high brightness, thereby making total color balance more difficult.

### SUMMARY

The present invention provides a liquid crystal display to display images by properly adjusting color balance.

According to an embodiment of the invention, there is provided a display device comprising a gate line; a data line insulated from the gate line and crossing the gate line; and a pixel area connected to a TFT formed at an intersection of the gate line and the data line and having a red, a green, a blue, and a white subpixels which are disposed in a 2×2 matrix, wherein one of areas of the red subpixel, the green subpixel, and the blue subpixel, and an area of the white subpixel are less than 25% of an area of the pixel area, respectively.

According to another embodiment of the invention, there is provided a display device comprising a gate line; a data line insulated from the gate line and crossing the gate line; a pixel area connected to a TFT formed at an intersection of the gate line and the data line and having a red, a green, a blue, and a white subpixels which are disposed in a 2×2 matrix; and a light source to provide light to the pixel area, wherein one of areas of the red subpixel, the green subpixel, and the blue subpixel, and an area of the white subpixel are less than 25% of an area of the pixel area, respectively, and the light source provides light of a color of a subpixel of which the area is less than 25% of the area of the pixel area.

Additional features of the invention will be set forth in the description which follows, and in part will be apparent from the description, or may be learned by practice of the invention.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an arrangement view of a display device according to a first embodiment of the present invention.

FIG. 2 is a drawing showing a pixel area according to a second embodiment of the present invention.

FIG. 3 is a drawing showing a pixel area according to a third embodiment of the present invention.

FIG. 4 is a sectional view of the display device according to the first embodiment of the present invention.

FIG. 5 and FIG. 6 are graphs illustrating a characteristic of a light source according to the first embodiment.

Embodiments of the present invention and their advantages are best understood by referring to the detailed description that follows. It should be appreciated that like reference numerals are used to identify like elements illustrated in one or more of the figures. It should also be appreciated that the figures may not be necessarily drawn to scale.

### DETAILED DESCRIPTION

Reference will now be made in detail to the embodiments of the present invention, examples of which are illustrated in the accompanying drawings, wherein like reference numerals refer to like elements throughout. The embodiments are described below so as to explain the present invention by referring to the figures.

A display device according to the present invention comprises a liquid crystal display, organic light emitting diode and an electro-phoretic indication display.

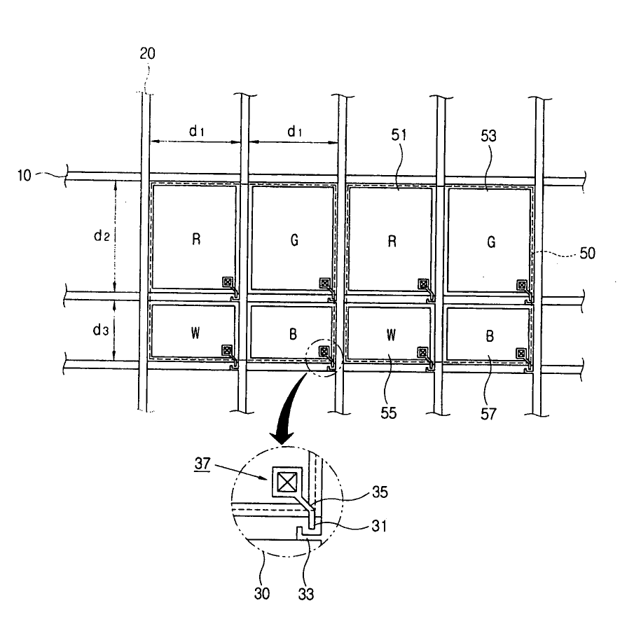

As shown in FIG. 1, the display device is a liquid crystal display (LCD). The LCD includes a gate line 10 extended in a horizontal direction, a data line 20 crossing the gate line 10, a TFT 30 disposed at an intersection of the gate line 10 and the data line 20, and a pixel area 50 including subpixels 51, 53, 55, 57 each electrically connected to a TFT 30. Also, the LCD further includes a gate driver and a data driver that are provided with a control signal from the outside to drive the gate line 10 and the data line 20, respectively.

A plurality of gate lines 10 are disposed parallel to one another and perpendicularly cross two data lines 20 to define a pixel area 50. A gate metal layer that forms the gate line 10 and a gate electrode 31 of the TFT 30 may be a single-layer or a multi-layer. The gate metal layer includes a conductive layer, in one example, formed of a silver-based metal such as silver or a silver alloy, or a aluminum-based metal such as aluminum or an aluminum alloy, which has low resistivity; and may further include a layer formed of chrome, titanium, tantalnum, molybdenum, or an alloy thereof, which effectively contacts a transparent electrode material with respect to physical, chemical, and electrical characteristics on the aforementioned conductive layer. The gate line 10 applies a gate on/off voltage to the TFT 30 connected to the gate line 10.

The LCD may further include a maintenance electrode formed on a metal layer such as a gate line 10 and applied with a certain level of common electrode to maintain a voltage applied to the liquid crystal layer.

The gate metal layer is covered with a gate insulating layer (not shown) formed of silicon nitride (SiNx) in one example. The gate insulating layer insulates the gate metal layer from a data metal layer.

On the gate insulating layer covering the gate electrode 31 are sequentially formed a semiconductor layer made of hydrogenated amorphous silicon or the like and an ohmic contact layer formed of n+hydrogenated amorphous silicone, which is highly-doped with n-type impurities.

The data metal layer includes the data line 20 crossing the gate line 10, a drain electrode 33 of a data electrode, and a source electrode 35, and is insulated from the gate metal layer via the gate insulating layer.

The data metal layer and the gate metal layer may each be formed in a multi-layer to complement defects of each metal or alloy thereof and to obtain an intended property. The multi-layer may be a triple-layer comprised of molybdenum (Mo), aluminum (Al), and molybdenum (Mo) in one example.

The drain electrode 33 of the TFT 30 is branched from the data line 20, and the source electrode 35 is separated from the drain electrode 33 across the semiconductor layer.

A protection layer is formed between the data metal layer and the pixel electrode forming the subpixels 51,53,55,57. A contact hole 37 is formed on the protection layer which covers the source electrode 35 and electrically connects the source electrode 35 and the subpixels 51,53,55,57.

The pixel area 50 is comprised of four subpixels 51,53,55,57 displaying a red, a green, a white, and a blue color, respectively, and the subpixels 51,53,55,57 are each connected to a TFT 30 to be disposed in a 2×2 matrix form. In this illustrated embodiment, the red subpixel 51 and the green subpixel 53 are disposed in a first row of the pixel area 50; and the white subpixel 55 and the blue subpixel 57 are disposed in a second row of the pixel area 50. That is, one pixel area 50 is divided by the data line 20 in the ratio of 1:1; and by the gate line 10 in the ratio of 2:1 in one example. As shown in FIG. 1, lengths d₁ of each of the subpixels 51, 53, 55, 57 in the direction parallel to the gate line 10 are the same. On the other hand, a length d₂ (in the direction parallel to data line 20) of subpixels 51 and 53 is about double a length d₃ (in the direction parallel to data line 20) of the subpixels 55 and 57.

Accordingly, the red subpixel 51 and the green subpixel 53 have the same area, and the white subpixel 55 and the blue subpixel 57 have the same area in one example. Only, the subpixels 55,57 in the second row have a smaller area than the subpixels 51,53 in the first row because the pixel area 50 is divided by the gate line 10 in a different ratio from 1:1. The total area of the white subpixel 55 and the blue subpixel 57 is about a half of the total area of the red subpixel 51 and the green subpixel 53 in one example. Thus, in the pixel area 50 according to this embodiment, the area of the white subpixel 55 is less than 25% of the total pixel area 50. The area of the white subpixel 55 is about 16% of the total pixel area 50 in a further example.

Advantageously, in this embodiment, the gate line 10 and the data line 20 may be easily formed as straight lines in a manufacturing process. Therefore, another subpixel having the same area as the white subpixel 55, that is, the blue subpixel 57, may easily be formed in the embodiment.

Preferably, the subpixel having the same area as the white subpixel 55 is the blue subpixel 57, which is lowest in brightness of the pixels. Therefore, the blue subpixel 57 least influences the total brightness of the subpixels, although the area thereof decreases.

The brightness of the blue is about 1/10 of the brightness of the green and absolute brightness is just tens of Cd/m², and therefore, the total brightness is not reduced that much although the brightness of the blue is reduced by half. Further, people have visual cells sensing a blue color least among the visual cells, which minimizes influence on images which users finally recognize.

When a conventional pixel area 50 is comprised of 4-color subpixels, one pixel area 50 is divided in the ratio of 1:1:1:1. Accordingly, all the subpixels have the same area, which is 25% of the total area. When the pixel area 50 is divided by the aforementioned ratio, brightnesses of pure colors decrease as compared with one in a pixel area of 3-color subpixels. Also, the total brightness tends to decrease because the white is high in the ratio. In the present invention, since the ratio of the white subpixel 55 decreases to solve the aforementioned disadvantages, the blue subpixel 57 need not have the same area as the white subpixel 55.

Moreover, it is proper color balance that the white subpixel 55 have an area about 0.5˜1 times the area of another color subpixel. Therefore, the ratio of lengths of the subpixels divided by the gate line 10 (d2:d3) is not limited to 2:1, but may be modified variously, from about 1:1 to about 2:1.

Accordingly, if the area of the white subpixel 55 is less than 25% of the total area of the pixel area 50, the white subpixel 55 and the subpixel which is disposed in the same row as the white subpixel 55 may be disposed in the first row. Also, the subpixel having the same area as the white subpixel 55 is not limited to the blue subpixel.

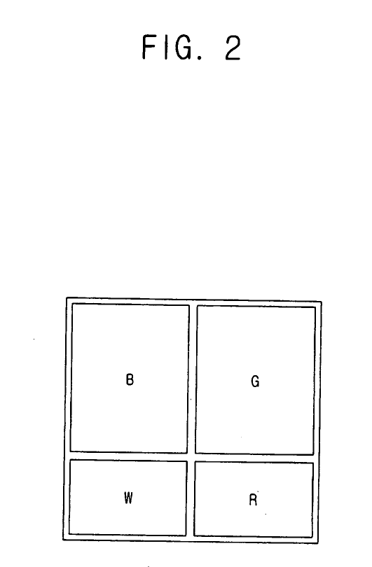

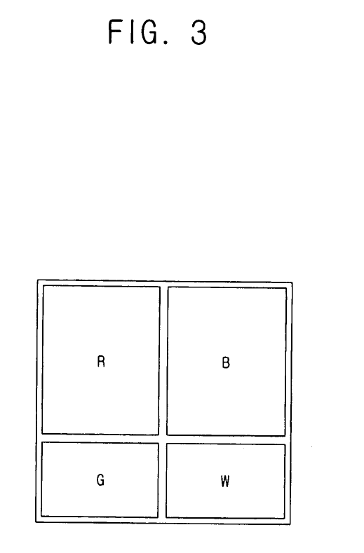

FIGS. 2 and 3 show a pixel area according to a second embodiment and a third embodiment of the present invention, respectively. A white subpixel is adjacent to a red subpixel in FIG. 2 and to a green subpixel in FIG. 3 in the direction of a gate line (in this case, a horizontal or row direction). In a first row of the pixel area are disposed a blue subpixel and a green subpixel in FIG. 2, and a red subpixel and a blue subpixel in FIG. 3. Since the subpixel disposed in the same row as the white subpixel has a smaller area, total color balance may not be proper, which is supplemented by a light source in accordance with the present invention.

In a display apparatus using 4-color subpixels displaying a red, a green, a blue, and a white color, the subpixels are disposed in various forms. The subpixels are disposed in a form of two columns and two rows in the exemplary embodiment or in a plurality of rectangular shapes having the same long sides and different short sides in another example.

Here, a display apparatus including 4-color subpixels is not limited to the LCD that is mentioned in the exemplary embodiment.

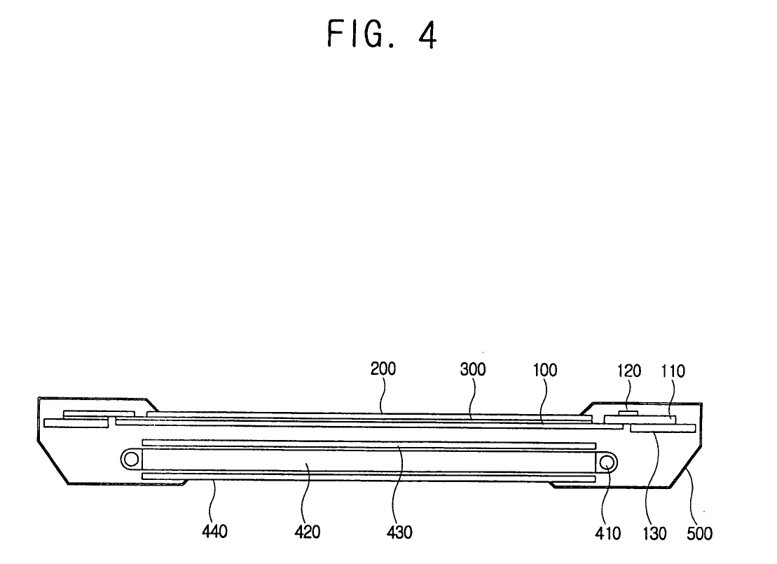

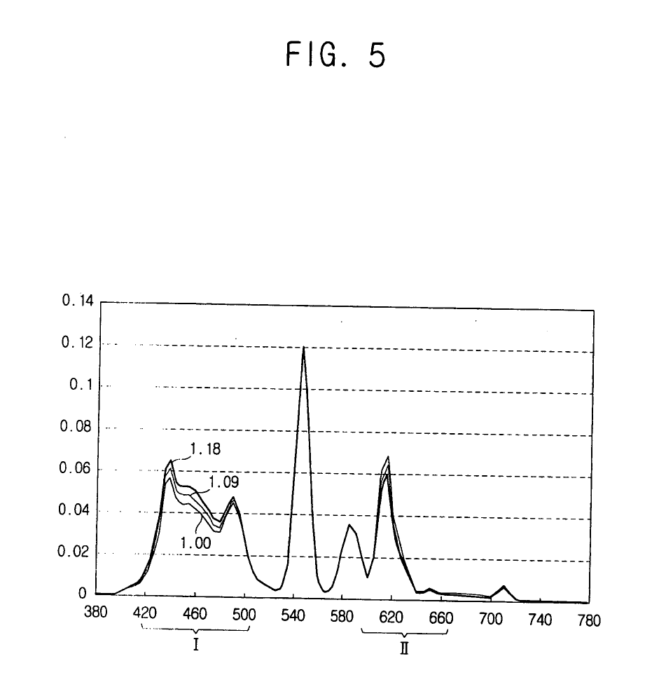

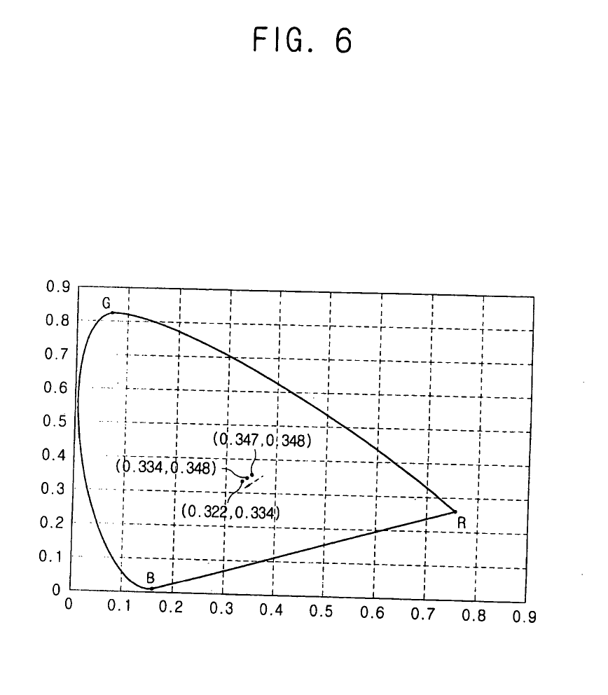

FIG. 4 is a sectional view of an LCD and FIGS. 5 and 6 are drawings illustrating a characteristic of a light source according to the first embodiment of the present invention.

As shown in FIG. 4, an LCD includes an LCD panel comprising a TFT substrate 100, a color filter substrate 200, and a liquid crystal layer 300 interposed between both substrates 100,200; a backlight unit 400 comprising a lamp 410 disposed in a rear of the LCD panel to provide light to the LCD panel; and a chassis 500 accommodating the LCD panel and the backlight unit 400.

The LCD panel includes the TFT substrate 100 where the pixel area 50 in FIG. 1 and TFTs 30 are formed, the color filter substrate 200 opposite to the TFT substrate 100, a sealant adhering both substrates 100,200 and forming a cell gap, and the liquid crystal layer 300 disposed between both substrates 100,200 and the sealant. The LCD panel displays images by adjusting alignment of the liquid crystal layer 300. However, the LCD panel is provided with light from a light source such as the lamp 410 disposed in the rear of the LCD panel. On one side of the TFT substrate 100 is provided a driving part to apply a driving signal. The driving part includes a flexible printed circuit (FPC) 110, a driving chip 120 mounted on the FPC 110, and a printed circuit board (PCB) 130 connected to one side of the FPC 110. The driving part is formed by a chip on film (COF) type in the embodiments of the present invention. However, the driving part may be formed of any well-known type, such as a tape carrier package (TCP), a chip on glass (COG), or the like. Also, the driving part may be formed on the TFT substrate 100 while lines are assembled.

A plurality of lamps 410 are disposed along both sides of a light guiding plate 420 in the rear of the LCD panel, wherein between the lamps 410 is disposed the light guiding plate 420 to lead light generated in the lamp 410 to the LCD panel. The lamp 410 may be disposed either in a direct type or in an edge type. In the direct type, the lamp 410 is disposed in the entire rear of the LCD panel to provide light to the LCD panel. In the edge type, the light guiding plate 420 is disposed in the rear of the LCD panel and the lamp 410 is disposed on at least one lateral side of the light guiding plate 420 to provide light through the light guiding plate 420 to the LCD panel, which is employed in the exemplary embodiment.

In one example, the lamp 410 is a cold cathode fluorescent lamp (CCFL) and includes a blue fluorescent element. Generally, the lamp 410 includes a red, a green, and a blue fluorescent element to generate white light. In a preferred embodiment, the lamp 410 includes a blue fluorescent element that is more intensified than the other fluorescent elements. As shown in FIG. 1, since the blue subpixel 57 has a smaller area than the red subpixel 51 or the green subpixel 53, the total color balance in the LCD panel may not be proper. In the exemplary embodiment, the lamp 410 may intensify an insufficient color element to supplement that color and remedy the disadvantage. Furthermore, in another example, an external electrode fluorescent lamp (EEFL) may be used as the lamp 410.

FIG. 5 is a graph showing brightness versus wavelength of light emitted from the lamp when using the lamp intensified with the blue fluorescent element. The graph shows brightness of the light when the blue element of a lamp is not intensified with a blue fluorescent element (in this example having a value of 1) and if the blue element is intensified by 1.09 times and 1.18 times.

In general, blue light has a wavelength between 420 nm˜500 nm and yellow light has a wavelength between 600 nm˜660 nm. As the blue element gets intensified, brightness of light emitted from the lamp increases gradually in an area I between about 420 nm˜500 nm and decreases gradually in an area II between about 600 nm˜660 nm. That is, since brightness of blue light of the area I increases in the lamp intensified with the blue fluorescent element, an insufficient blue element in the LCD panel is supplemented. Likewise, it is confirmed whether the blue element is intensified as comparing wavelengths of the light, in specific areas, generated from a lamp not intensified with the blue fluorescent element and a lamp intensified with the blue fluorescent element.

FIG. 6 is a graph illustrating a CIE's (Commission Internationale de l'Eclairage) color coordinate system showing a result when using the lamp intensified with the blue fluorescent element. The CIE's color coordinate system shows blue light in a lower left area, green light in an upper left area, and red light in a right area.

Provided that the blue element of the lamp not intensified with the blue fluorescent element is given a value of 1, a center of the color area over the light is about (0.347, 0.383). It shows that a lamp has a considerable yellow characteristic, which is alike to one used for an LCD panel including 3-color subpixels.

On the other hand, if the blue element is intensified by 1.09 times, the center of the color area transfers to (0.334, 0.348) and if the blue element is intensified by 1.18 times, the center of the color area transfers to (0.322, 0.334). It shows that the blue element of the lamp is totally intensified. Accordingly, using the lamp intensified with the blue element supplements the blue color, with respect to color balance, typically decreased by the smaller area of the blue subpixel.

A diffusion plate 430 (FIG. 4) disposed in a rear of the LCD panel diffuses light from the light source to provide it to the LCD panel. Accordingly, an alignment of light source is not recognized on the screen and the brightness of the screen is totally uniform.

The reflective sheet 440 disposed in a rear of the light guiding plate 420 reflects light leaking from the LCD panel and provides the light again to the LCD panel, thereby reducing light loss and enhancing uniformity of light. The reflective sheet 440 may be formed of polyethylene terephthalate (PET) or phlycarbonate (PC) in one example.

The LCD further includes a light control member comprising at least one of a prism film, a protective film, and a reflective polarizing film which are disposed between the LCD panel and the diffusion plate 430. The prism film collects the light diffused in the diffusion plate 430 to direct the light in the perpendicular direction to the LCD panel, the protective film protects the prism film from scratches, and a reflective polarizing film controls polarization, transmission, and reflectance of the light so that the LCD has higher brightness. Generally, a diffusion pattern is formed on the light control member to enhance diffusion of light.

In another embodiment, a plurality of LEDs may be used as a light source instead of the lamp 410, and a larger number of LEDs emitting a color associated with a smaller subpixel area may be mounted. In one case, where the area of the blue subpixel is smaller, more LEDs emitting a blue color may be mounted than LEDs emitting a red color or a green color.

The lamp 410 includes the blue fluorescent element according to the exemplary embodiment, while the red or green fluorescent element may get supplemented if the red subpixel or the green subpixel has a smaller area as shown in FIGS. 2 and 3, respectively. That is, the light source supplements a color of subpixel of which the area is less than 25% of the pixel area in one embodiment.

If the red subpixel has the same area as the white subpixel, as shown in FIG. 2, the lamp 410 includes more of the red fluorescent element or the red LED increases in number. Likewise, if the green subpixel has the same area as the white subpixel, as shown in FIG. 3, the lamp 410 comprises more of the green fluorescent element more or the green LED increases in number.

It will be apparent to those skilled in the art that various modifications and variations can be made in the present invention without departing from the spirit or scope of the invention. Thus it is intended that the present invention cover the modifications and variations of this invention provided they come within the scope of the appended claims and their equivalents.

What is claimed is:

1. A display device, comprising:
a gate line;
a data line crossing the gate line; and
a pixel area connected to a thin film transistor formed at an intersection of the gate line and the data line, the pixel area having a red subpixel, a green subpixel, a blue subpixel, and a white subpixel disposed in a 2×2 matrix,
wherein the white subpixel and one of the red subpixel, the green subpixel, and the blue subpixel each have an area less than 25% of the pixel area.

2. The display device of claim 1, wherein the areas of the subpixels which are adjacent in the direction of the gate line are the same.

3. The display device of claim 1, wherein one of the areas of the subpixels which are adjacent in the direction of the data line is between about 0.5˜1 times the area of the other.

4. The display device of claim 1, wherein one of the areas of the red subpixel, the green subpixel, and the blue subpixel is the same as the area of the white subpixel.

5. The display device of claim 1, wherein the blue subpixel is adjacent to the white subpixel in a row direction.

6. The display device of claim 1, wherein the red subpixel is adjacent to the white subpixel in a row direction.

7. The display device of claim 1, wherein the green subpixel is adjacent to the white subpixel in a row direction.

8. The display device of claim 1, further comprising a light source for providing light to the pixel area, wherein the light source provides light of a color of a subpixel of which the area is less than 25% of the pixel area.

9. The display device of claim 8, wherein the light source is one of a lamp and an LED.

10. The display device of claim 9, wherein the lamp is a cold cathode fluorescent lamp having a blue fluorescent element.

11. The display device of claim 9, wherein the LED comprises a red, a blue, and a green LED and the blue LED is provided more than the red LED or the green LED.

12. The display device of claim 1, further comprising a liquid crystal display, an organic light emitting diode, and an electro-phoretic indication display.

13. A display device, comprising:
a gate line;
a data line insulated from the gate line and crossing the gate line;
a pixel area connected to a thin film transistor formed at an intersection of the gate line and the data line and having a red, a green, a blue, and a white subpixel which are disposed in a 2×2 matrix; and
a light source for providing light to the pixel area,
wherein one of the areas of the red subpixel, the green subpixel, and the blue subpixel, and an area of the white subpixel are each less than 25% of the pixel area, respectively, and the light source provides light of a color of a subpixel of which the area is less than 25% of the pixel area.

14. The display device of claim 13, wherein the areas of the subpixels which are adjacent in the direction of the gate line are the same.

15. The display device of claim 13, wherein one of the areas of the subpixels which are adjacent in the direction of the data line is between about 0.5 and about 1 times the area of the other.

16. The display device of claim 13, wherein one of the areas of the red subpixel, the green subpixel, and the blue subpixel is the same as the area of the white subpixel.

17. The display device of claim 13, wherein the area of the white subpixel is about 16% of the pixel area.

18. The display device of claim 13, wherein the light source is one of a cold cathode fluorescent lamp and an external electrode fluorescent lamp.

19. The display device of claim 13, wherein the light source is an LED comprising a red, a blue, and a green LED, and the blue LED is provided more than the red LED or the green LED.
